(19) United States
(12) Patent Application Publication
(10) Pub. No.: US 2007/0026297 A1
(43) Pub. Date: Feb. 1, 2007

(54) Battery cover latching mechanism for portable electronic device

(75) Inventors: Zhong-Shu Qin, Shenzhen (CN); Rui-Hao Chen, Shenzhen (CN); Hsiao-Hua Tu, Tu-Cheng (TW); Chia-Hua Chen, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO., LTD., Shindian City (TW)

(21) Appl. No.: 11/416,302

(22) Filed: May 1, 2006

(30) Foreign Application Priority Data
Jul. 29, 2005 (CN) 200510036287.4

(51) Int. Cl. H01M 2/10

(52) U.S. Cl. 429/97; 429/100

(57) ABSTRACT

A battery cover latching mechanism (300) is used in a portable electronic device. The portable electronic device has a housing (10) and a battery cover (20). The battery cover latching mechanism comprises a fixing portion (206) formed on the battery cover, a locking member (30) and a switch (40). The locking member is mounted on the housing and slidable between a first position where the locking member engages with the housing and the battery cover and a second position where the locking member detaches with the housing and the battery cover relative to the housing. The switch is rotatably mounted on the housing. The switch engages with the locking member. The rotation of the switch urges the locking member to slide from the first position to a second position.

### BACKGROUND OF THE INVENTION

1. Field of the Invention

The present application generally relates to battery cover latching mechanisms and, more particularly, to a battery cover latching mechanism for a portable electronic device.

2. Discussion of the Related Art

Batteries are widely used in portable electronic devices, such as personal digital assistants (PDAs), mobile phones and so on. Conventional batteries are attachably received in housings of the electronic devices, and battery covers are designed to connect with the housings so as to enclose and protect the batteries. The batteries have to be replaced by removing the battery covers when the batteries are, for example, damaged, exhausted, and/or in need of recharging or replacement.

A clasping structure or latching structure is used to engage a conventional battery cover with a housing of a portable electronic device. A typical latching mechanism includes a pair of hooks at one end of the battery cover and a locking pin protruding from the other end of the battery cover. Accordingly, a pair of grooves is defined in one end portion of a backside of a housing of the mobile phone, and a locking hole is defined in the other end portion of the backside of the housing. In assembly, the hooks are first inserted into the grooves in the backside of the housing, then, the battery cover is pressed downwardly to the housing until the locking pin on the battery cover is inserted into the locking hole in the backside of the housing. The battery cover is thus assembled to the housing of the mobile phone. The latching mechanism is simple in structure, and the engagement between the battery cover and the housing of the mobile phone is firm. However, during disassembly, great effort is needed to disassemble the battery cover, thereby requiring a relatively substantial force to be exerted thereon. Therefore, the battery cover is susceptible to damage. As a result, it is difficult for a user to replace a battery in the conventional housing of the mobile phone.

Therefore, a new battery cover latching mechanism is desired in order to overcome the above-described shortcomings.

### SUMMARY OF THE INVENTION

A battery cover latching mechanism is used in a portable electronic device. The portable electronic device has a housing with a first side and a second side and a battery cover. The battery cover latching mechanism comprises a fixing portion formed on the battery cover, a locking member and a switch. The locking member is slidably mounted on the housing and is slidable between a first position where the locking member engages with the housing and the battery cover and a second position where the locking member detaches with the housing and the battery cover relative to the housing. The switch is rotatably mounted the housing. The switch engages with the locking member at the second side and is exposed from the first side of the housing. The rotation of the switch urges the locking member to slide from the first position to a second position.

Other advantages and novel features of the embodiments will become more apparent from the following detailed description thereof, when taken in conjunction with the accompanying drawings.

### BRIEF DESCRIPTION OF THE DRAWINGS

Many aspects of the battery cover latching mechanism can be better understood with reference to the following drawings. The components in the drawings are not necessarily to scale, the emphasis instead being placed upon clearly illustrating the principles of the present battery cover latching mechanism and its potential applications. Moreover, in the drawings, like reference numerals designate corresponding parts throughout the several views.

FIG. 1 is an exploded, isometric view of a battery cover latching mechanism for connecting a battery cover and a housing of a portable electronic device, in accordance with a preferred embodiment;

FIG. 2 is similar to FIG. 1 but viewed from another aspect;

FIG. 3 is an assembled, isometric view of the battery cover latching mechanism assembled on the housing of the portable electronic device in FIG. 1;

FIG. 4 is similar to FIG. 3 but viewed from another aspect;

FIG. 5 is a partial cross-sectional view of the assembled battery cover latching mechanism latching the battery cover on the housing in FIG. 1, showing a latching state; and

FIG. 6 is similar to FIG. 5, but showing a detached state.

### DETAILED DESCRIPTION OF THE EMBODIMENTS

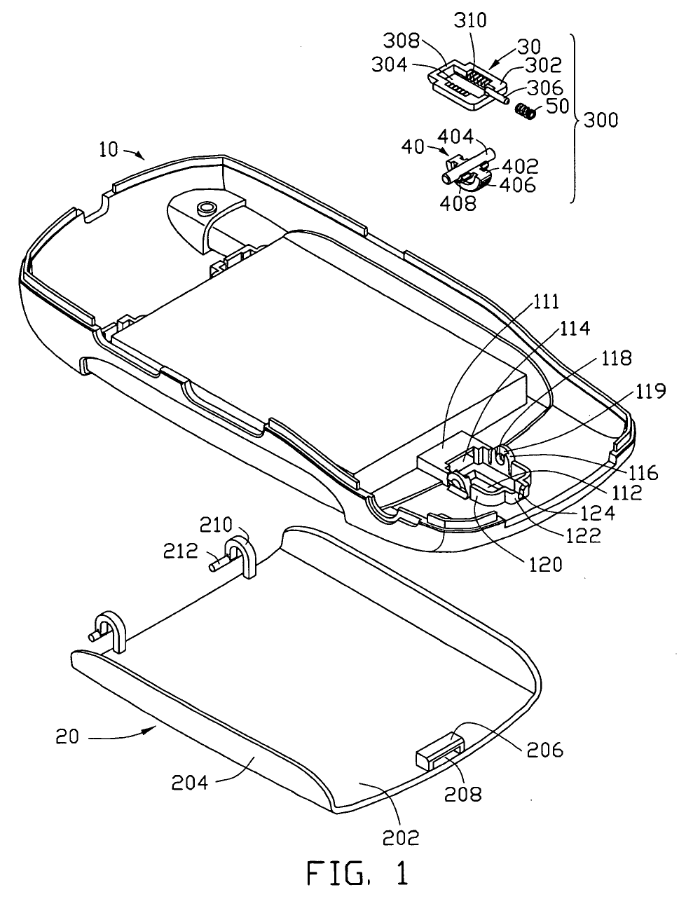

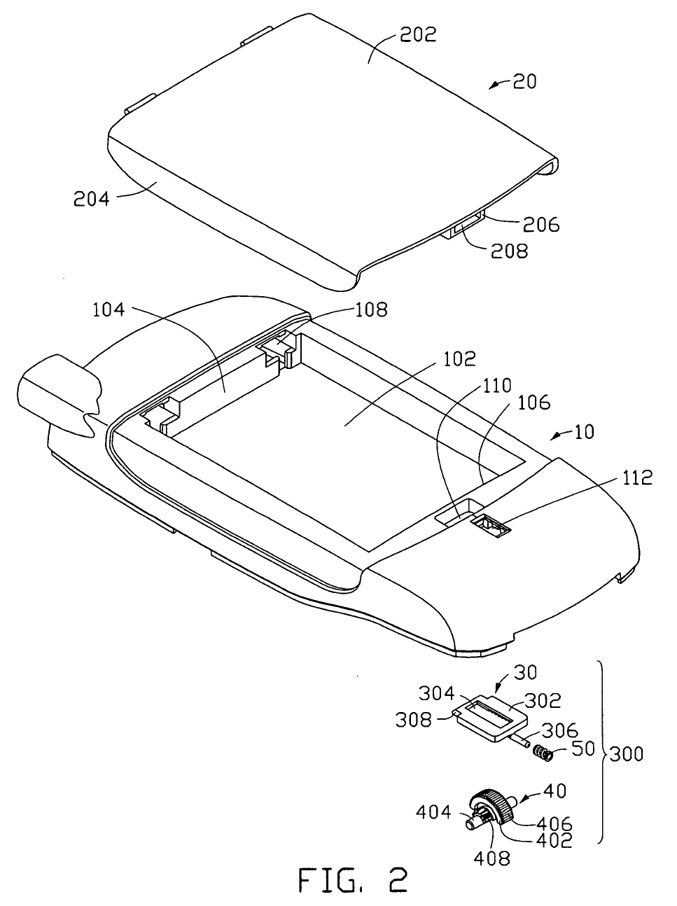

Referring now to the drawings in detail, FIGS. 1 and 2 each show a battery cover latching mechanism 300 for use in a mobile phone from different aspects. The mobile phone is taken here as an exemplary application for the purposes of describing details of the battery cover latching mechanism of a preferred embodiment of the present application. The mobile phone includes a housing 10 and a battery cover 20, connected together via the battery cover latching mechanism 300. The latching mechanism 300 includes a locking member 30, a switch 40 and an elastic member 50. The latching mechanism 300 is mounted in the housing 10 and releasably locks the battery cover 20, thereby interconnecting the housing 10 and the battery cover 20.

The housing 10 acts as a rear cover for the mobile phone. A cavity 102 for accommodating a battery (not shown) is defined in a first side of the housing 10. The housing 10 has a frontwall 104 at one end of the cavity 102 and a rearwall 106 at an opposite end of the cavity 102. The housing 10 defines two slots 108 adjacent to the frontwall 104, a groove 110 adjacent to the rearwall 106, and a receiving hole 112 next to the groove 110. The groove 110 is arranged between the cavity 102 and the receiving hole 112 of the housing 10. The housing 10 forms a hollow block 111 at a second side thereof The groove 110 is defined in the hollow block 111. The housing 10 defines a cutout 114 to communicate the groove 110 and the receiving hole 112. Two holding bases 116 are formed on the second side of the housing 10 extending from two sides of the cutout 114. Each holding base 116 defines a holding hole 118 in the center thereof and a guiding slot 119 running from an edge of the holding base 116 to a periphery of the holding hole 118. A strip 120 formed on the housing 10 is connected to each of the holding bases 116. The ends of the strips 120 which face away from the holding bases 116 are perpendicularly bent towards each other, thereby forming two supporting portions 122. A supporting hole 124 is defined between the supporting portions 122 and opposite to the cutout 114.

The battery cover 20 is approximately a rectangular board including a bottom wall 202 and two side walls 204. A fixing portion 206 is formed on one end of the battery cover 20 and a pair of hooks 210 are formed on an opposite end of the battery cover 20. Facing the exterior of the battery cover 20, a hollow 208 is defined in the fixing portion 206. An engaging pole 212 is formed on the ends of each hook 210. The hooks 210 and the engaging poles 212 are configured to engage with the slots 108 of the housing 10.

The locking member 30 includes a base portion 302. The base portion 302 defines a hole 304 in the center thereof A mounting pole 306 is formed on one end of the base portion 302 and a protrusion 308 is formed on an opposite end of the base portion 302. With the protrusion 308 protruding in the groove 110 of the housing 10 and the mounting pole 306 resting on the supporting portion 122, the locking member 30 is mounted between the holding bases 116 of the housing 10. The base portion 302 defines a number of teeth 310 on one side thereof The teeth 310 are defined at two opposite sides of the hole 304 of the base portion 302 and array in a direction parallel to an axis of the mounting pole 306. The elastic member 50 is a helical, column-shaped spring. The elastic member 50 surrounds the mounting pole 306 and has an end resisting the base portion 302 and an opposite end resisting the supporting portions 122.

The switch 40 includes an operating portion 402 and a shaft portion 404 configured for rotatably engaging in the holding holes 118 of the housing 10. The operating portion 402 is a semi-cylinder and has a number of grooves 406 on the peripheral surface for increasing friction during operation of the switch 40. The shaft portion 404 is cylinder-shaped and is fixed relative to the operating portion 402. The operating portion 402 and the shaft portion 404 are coaxial. The shaft portion 404 is longer than the operating portion 402, and the operating portion 402 is disposed at the middle of the shaft portion 404. The shaft portion 404 is either manufactured together with the operating portion 402 or manufactured separately and locked on the operating portion 402. Two semi-gears 408 (i.e., a gear is semi-cylindrical shaped) are formed on the shaft portion 404 and arranged at two sides of the operating portion 402. The semi-gears 408 are coaxial with the operating portion 402. The semi-gears 408 are configured for engaging with the teeth 310 of the locking member 30, thereby transforming linear movement and rotation to each other.

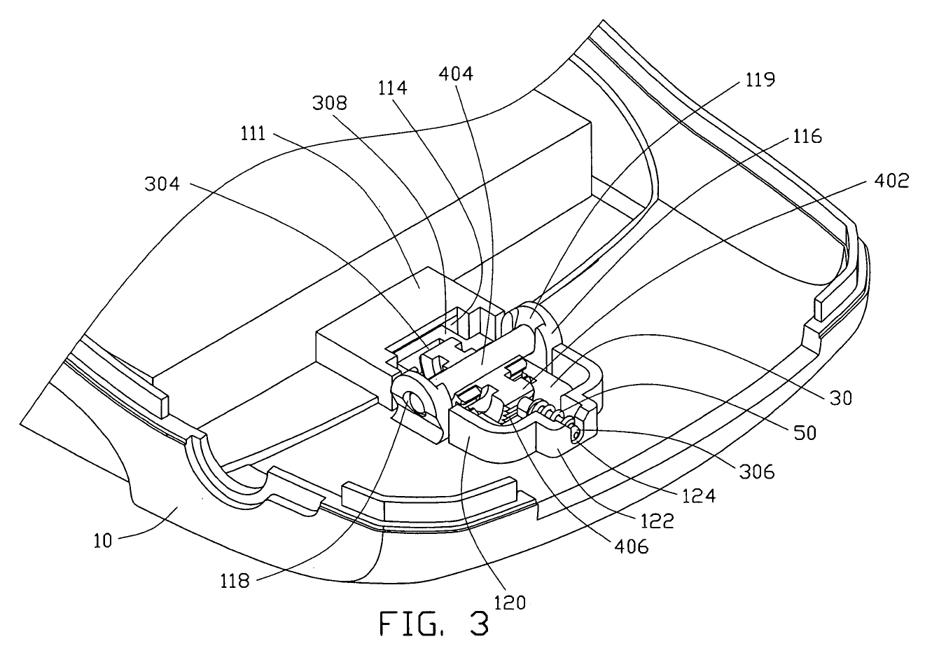

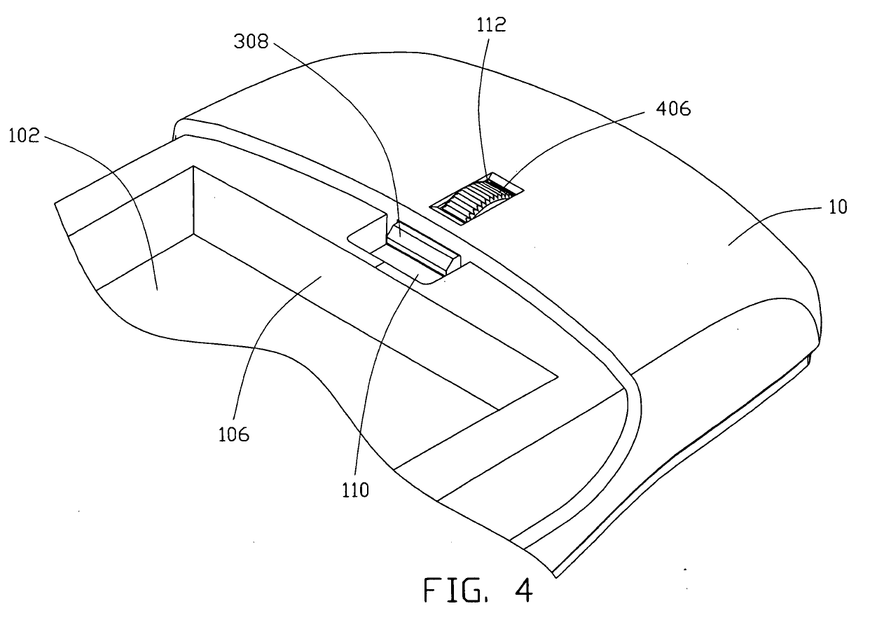

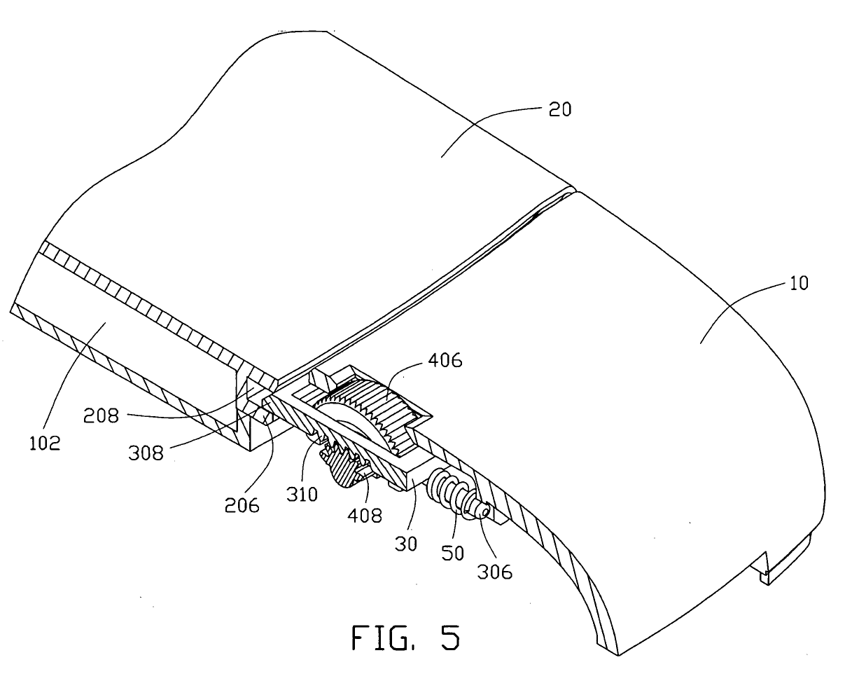

Referring to FIGS. 3-5, the latching mechanism 300 is assembled on the housing 10. The elastic member 50 is arranged around the mounting pole 306. With the teeth 310 exposed from the second side of the housing 10, the locking member 30 is mounted between the holding bases 116. The locking member 30 is slidable from a first position to a second position relative to the housing 10. An end of the mounting pole 306 is received in the supporting hole 124 and the protrusion 308 protrudes into the groove 110 of the housing 10 via the cutout 114 (i.e. the first position). The hole 304 of the locking member 30 is positioned corresponding to and in communication with the receiving hole 112 of the housing 10. One end of the elastic member 50 resists the supporting portions 122 and an opposite end of the elastic member 50 resists an end of the base portion 302 of the locking member 30. The elastic member 50 is compressed to a length shorter than its natural length. Then two ends of the shaft portion 404 of the switch 40 are each<rotatably inserted into a separate holding hole 118 via the guiding slots 119. When assembling the switch 40, the shaft portion 404 is put on the top of the holding bases 116 and then pressed downwards. The operating portion 402 is partly received in the hole 304 of the locking member 30 and the receiving hole 112 of the housing 10 so as to expose a part of the operating portion 402 out of the housing 10 from the first side. The semi-gears 408 of the switch 40 mesh with the teeth 310 of the locking member 30. Rotation of the shaft portion 404 allows the switch 40 rotating relative to the housing 10 and urges the locking member 30 sliding relative to the housing 10.

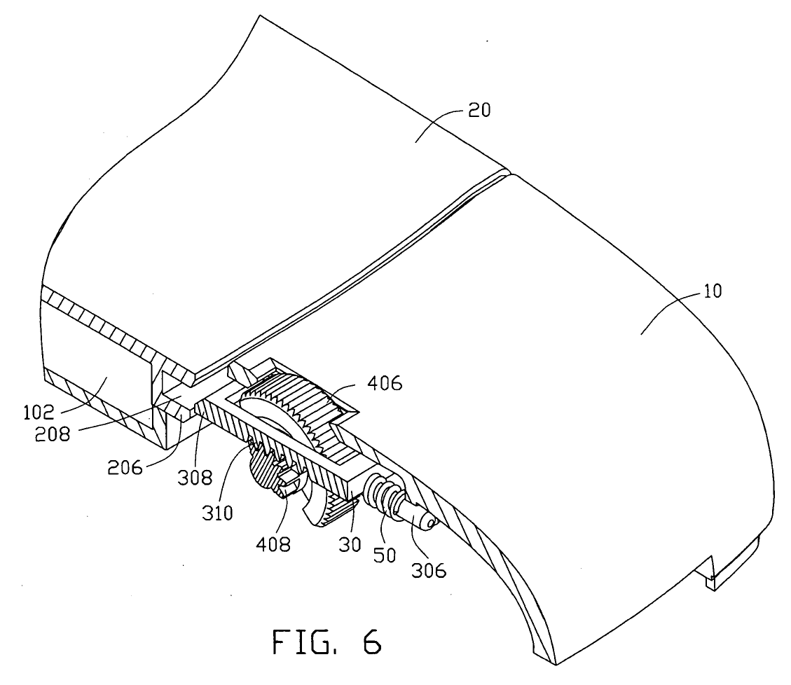

Referring to FIG. 6, when the battery cover 20 is assembled to the housing 10, the battery cover 20 is located on the housing 10. The hooks 210 of the battery cover 20 engage into the slots 108 of the housing 10. Rotating the operating portion 402 of the switch 40, the switch 40 rotates relative to the housing 10. The engagement of the semi-gears 408 of the switch 40 and the teeth 310 of the locking member 30 further compresses the locking member 30 slide and the elastic member 50. Then the protrusion 308 of the locking member 30 withdraws from the groove 110 of housing 10 (i.e. the second position). The battery cover 20 is then pressed to make the battery cover 20 engage with the housing 10. The switch 40 is then released and a force generated by the elastic member 50 pushes the locking member 30 to the first position where the protrusion 308 of the locking member 30 protrudes into the groove 110 so as to engage with the hollow 208 of the fixing portion 206 of the battery cover 20. The locking member 30 moves to return to its first position and the switch 40 is urged to rotate. Thus, the battery cover 20 is firmly mounted on the housing 10.

When the battery cover 20 is detached from the housing 10 by rotating the operating portion 402 of the switch 40. The semi-gears 408 rotate together with the operating portion 402. The engagement of the semi-gears 408 and the teeth 310 of the locking member 30 makes the locking member 30 slide and the elastic member 50 is therefore further compressed. Then the protrusion 308 of the locking member 30 withdraws from the groove 110 of housing 10 (i.e. the second position). The battery cover 20 may be removed from the housing 10. The switch 40 is then released and a force generated by the elastic member 50 pushes the locking member 30 to the first position where the protrusion 308 of the locking member 30 protrudes into the groove 110. The locking member 30 moves to return to its first position and the switch 40 is urged to rotate.

As described above, the preferred embodiment provides a battery cover latching mechanism for portable electronic devices, such as mobile phones. The battery cover is removed easily by simply rotating the switch 30. This latching mechanism gives the user a both quick and user-friendly method for latching/unlatching a structure. It is also to be understood that such a latching mechanism could prove useful in allowing releasable attachment of covers or doors of other devices, and such uses are considered to be within the scope of the present latching mechanism.

In an alternative embodiment, the elastic member 50 can be made of other kinds of materials such as rubber tubes. The mounting pole 306 and the elastic member 50 can be replaced by an elastic pole. The engagement of the semi-gears 408 and the teeth 310 of the locking member 30 can be replaced by other driving mechanisms such as worm and worm wheel engagement, or screw bar and nut engagement.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed

What is claimed is:

1. A battery cover latching mechanism for use in a portable electronic device, the portable electronic device having a housing defining a receiving hole therein and a battery cover, the battery cover latching mechanism comprising:
a fixing portion formed on the battery cover;
a locking member mounted on the housing, the locking member having a plurality of teeth positioned thereon, the locking member being slidable between a first position where the locking member engages with the fixing portion of the battery cover and a second position where the locking member disengages from the fixing portion of the battery cover; and
a switch being rotatably received in the receiving hole of the housing, the switch forming a gear thereon for operatively engaging with the teeth of the locking member in such a way that rotation of the switch drives the locking member to slide from the first position to the second position.

2. The battery cover latching mechanism as claimed in claim 1, wherein the battery cover further comprises an elastic member for urging the locking member to slide from the second position to the first position automatically and then urge the switch to return to its original position.

3. The battery cover latching mechanism as claimed in claim 2, wherein the housing has a first side and a second side, the housing defines a cavity for receiving a battery and two slots at one end of the cavity at the first side, the receiving hole is defined adjacent to an opposite end of the cavity, a groove is defined between the cavity and the receiving hole for receiving the fixing portion of the battery cover.

4. The battery cover latching mechanism as claimed in claim 3, wherein the housing forms a hollow block at a second side for defining the groove, the housing has two holding bases each having a holding hole extended from the hollow block.

5. The battery cover latching mechanism as claimed in claim 4, wherein the battery cover has a pair of hooks opposite to the fixing portion for engaging in the slots of the housing and are formed on two ends of the battery cover.

6. The battery cover latching mechanism as claimed in claim 5, wherein the locking member has a base portion forming a protrusion on one end, the protrusion protrudes into the groove of the housing and engages in a hollow defined in the fixing portion of the battery cover.

7. The battery cover latching mechanism as claimed in claim 6, wherein the locking member forms a mounting pole on an opposite end, the elastic member surrounds the mounting pole of the locking member, the elastic member is a helical, column-shaped spring, one end of the spring resists the housing and an opposite end of the spring resists the locking member.

8. The battery cover latching mechanism as claimed in claim 6, wherein the switch has an operating portion and a shaft portion, the shaft portion is rotatably mounted in the housing for allowing the switch to rotate relative to the housing.

9. The battery cover latching mechanism as claimed in claim 8, wherein the locking member further defines a hole in the base portion, the operating portion of the switch protrudes out from the housing via the hole of the locking member and the receiving hole of the housing, two ends of the shaft portion of the switch are rotatably inserted into the holding holes of the housing.

10. A portable electronic device comprising:
a housing;
a battery cover removably mounted on the housing; and
a latching mechanism, the latching mechanism comprising:
a fixing portion formed on the battery cover;
a locking member mounted on the housing, the locking member having a plurality of teeth positioned thereon, the locking member being slidable between a first position where the locking member engages with the fixing portion of the battery cover and a second position where the locking member disengages from the fixing portion of the battery cover; and
a switch being rotatably attached to the housing, the switch forming a gear thereon configured for operatively engaging with the teeth of the locking member in such a way that rotation of the switch drives the locking member to slide from the first position to the second position.

11. The portable electronic device as claimed in claim 10, wherein the battery cover further comprises an elastic member for urging the locking member to slide from the second position to the first position automatically and then urge the switch to return to its original position.

12. The portable electronic device as claimed in claim 11, wherein the housing has a first side and a second side, the housing defines a cavity for receiving a battery and two slots at one end of the cavity at the first side, a receiving hole is defined adjacent to an opposite end of the cavity, a groove is defined between the cavity and the receiving hole for receiving the fixing portion of the battery cover.

13. The portable electronic device as claimed in claim 12, wherein the housing forms a hollow block at a second side, the housing has two holding bases each having a holding hole extended from the hollow block.

14. The portable electronic device as claimed in claim 13, wherein the battery cover has a pair of hooks opposite to the fixing portion for engaging in the slots of the housing, the hooks being formed on two ends of the battery cover.

15. The portable electronic device as claimed in claim 14, wherein the locking member has a base portion forming a protrusion on one end, the protrusion protrudes into the groove of the housing and engages in a hollow defined in the fixing portion of the battery cover.

16. The portable electronic device as claimed in claim 15, wherein the locking forms a mounting pole on an opposite end, the elastic member surrounds the mounting pole of the locking member, the elastic member is a helical, column-shaped spring, one end of the spring resists the housing and an opposite end of the spring resists the locking member.

17. The portable electronic device as claimed in claim 15, wherein the switch has an operating portion and a shaft portion, the shaft portion is rotatably mounted in the housing for allowing the switch to rotate relative to the housing, the locking member further defines a hole in the base portion, the operating portion of the switch protrudes out from the housing via the hole in the locking member and the receiving hole of the housing, two ends of the shaft portion of the switch are rotatably inserted into the holding holes of the housing.

18. A portable electronic device comprising:
a housing having first and second opposite housing sides facing away from each other, the housing defining a cavity in the first housing side, the cavity being configured for receiving a battery therein;
a battery cover, the battery being movable into a closed position for covering the cavity, and movable into an opened position for exposing the cavity, the battery cover forming a fixing portion thereon;
a locking member movably attached to the second housing side, the locking member engaging with the fixing portion of the battery cover when the battery cover is in the closed position thereby preventing the battery cover form moving toward the opened position, the locking member disengaging from the fixing portion when the battery cover is in the opened position; and
a switch rotatably attached to the housing, the switch having an engaging portion located at the second housing side and operatively engaging with the locking member, and an operation portion exposed to an outside from the first housing side, the switch driving the locking member to disengage from the fixing portion when the operation portion is pushed to rotate.

19. The portable electronic device as claimed in claim 18, wherein the locking member defines a plurality of teeth, the switch forms a gear for engages with the teeth of the locking member.

20. The portable electronic device as claimed in claim 18, further comprising a spring member configured for biasing the locking member into engagement with the fixing portion when the cover is in the closed position.
